(19) United States
(12) Patent Application Publication
(10) Pub. No.: US 2014/0205407 A1
(43) Pub. Date: Jul. 24, 2014

(54) Hand Truck For Moving Heavy Logs or Other Heavy Material

(71) Applicant: Fort Defiance Industries, Loudon, TN (US)

(72) Inventor: Christopher Michael Yerger, Knoxville, TN (US)

(73) Assignee: Fort Defiance Industries, Loudon, TN (US)

(21) Appl. No.: 14/160,776

(22) Filed: Jan. 22, 2014

Related U.S. Application Data
(60) Provisional application No. 61/756,108, filed on Jan. 24, 2013.

(51) Int. Cl. B62B 1/14

(52) U.S. Cl. CPC B62B 1/14
USPC 414/490; 414/812

(57) ABSTRACT

A hand truck for moving logs or other heavy material is disclosed. The hand truck includes a frame having a first section for being gripped by a user to manipulate and push the hand truck. The second section defines a carriage extending outwardly from the first section. The carriage serves as a loading platform for holding and supporting material such as a log loaded thereon. A pair of wheels are provided to enable ready movement of the hand truck over a supported surface such as the ground. To facilitate loading and storing a log during transportation, a loading strap is provided upon which a log can be rolled. The outermost end portion of the strap can then be gripped and moved towards the hand truck to enable movement of the log along the strap as it is advanced towards the carriage for storage and transportation.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The present invention relates generally to a hand truck for moving logs or other heavy material. More particularly, the invention is directed towards a hand truck which can be used for readily loading and transporting logs or the like to the back of a truck/trailer or log splitter.

2. Description of the Related Art

Large tree logs are difficult to move because they are heavy and hard to grasp. Normally the length of each log section should be of a size that will fit a standard fireplace. Typically, the logs are transported to a log splitter or pick-up truck/trailer. Moreover, logs may weigh up to 400 lbs. and sometimes lay where the terrain makes access very difficult. The current invention is provided with an improved carriage for loading and storing a log for transport and discharge. While it is burdensome to carry logs or the like in a wheelbarrow to a trailer or a truck bed, the carriage of the present invention has an outboard end portion upon which a log or the like can be rolled, lifted and secured for transport over rough terrain.

### BRIEF SUMMARY OF THE INVENTION

Described herein is a hand truck for moving logs or other heavy material. In some of its many embodiments, the present general inventive concept provides a hand truck that includes a frame having a first section for being gripped by a user to manipulate and push the hand truck. The second section defines a carriage extending outwardly from the first section. The carriage serves as a loading platform for holding and supporting material such as a log loaded thereon. A pair of wheels are provided to enable ready movement of the hand truck over a supported surface such as the ground. To facilitate loading and storing a log during transportation, in some of its many embodiments, the present general inventive concept may also include a loading strap, provided upon which a log can be rolled. The outermost end portion of the strap can then be gripped and moved towards the hand truck to enable movement of the log along the strap as it is advanced towards the carriage for storage and transportation.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of the hand truck without the loading strap;

FIGS. 2a and 2b show side views of the hand truck of FIG. 2 in loading and transporting positions, respectively;

FIG. 3 is a perspective view of one embodiment of the hand truck having a loading strap showing features of the present invention;

FIGS. 4a to 4c show a series of steps for loading a log without using the loading strap;

FIGS. 5a to 5d show a series of steps for loading a log using the loading strap.

### DETAILED DESCRIPTION OF THE INVENTION

In accordance with several features of the present general inventive concept, various exemplary embodiments of a hand truck for moving and handling logs or other heavy material is disclosed herein.

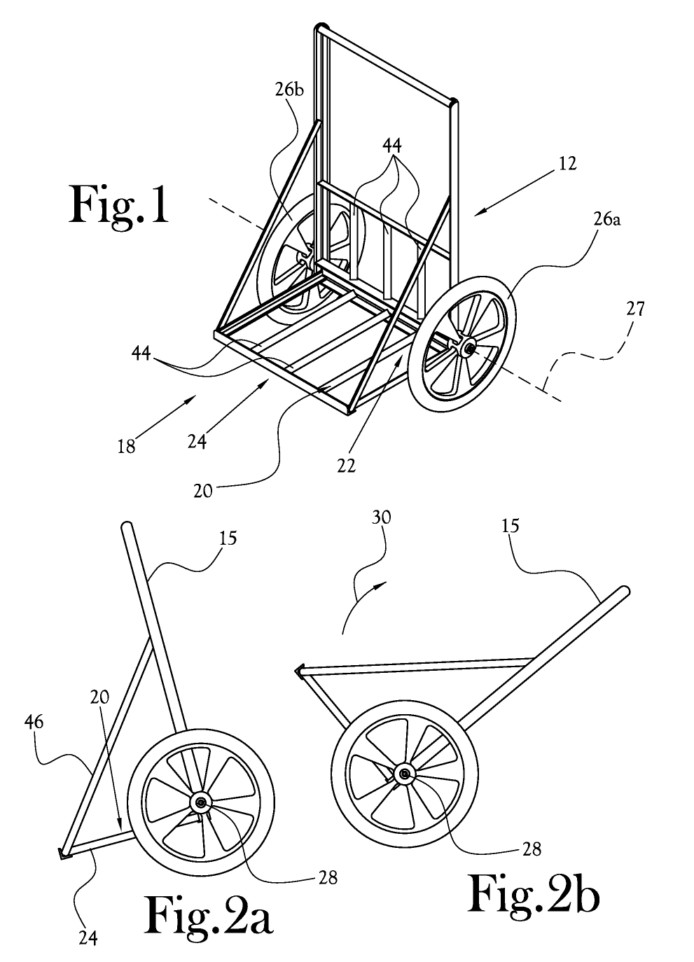

One embodiment of a hand truck constructed in accordance with several features of the present general inventive concept is illustrated in FIG. 1. With reference to FIG. 1, the hand truck 10 includes a frame 12 having a first section 14 that is defined in the illustrated embodiment by a pair of upright rails 15 having upper and lower end portions and which define an opening through which an operator can reach. The upper end portions of the rails 15 are connected by a handle 16 suitable for being gripped by a user for manipulating and pushing the hand truck. The second section 18 of the frame 12 defines a carriage 20 which extends outwardly from the lower end portions of the rails opposite the end portions upon which the handle 16 is mounted. It will be noted that the carriage extends outwardly from the rails 15 and an angle of approximately 90°. This carriage 20 serves as a loading platform for loading and transporting heavy materials such as logs. Moreover, it includes an inboard end portion 22 connected to the rails and an outboard end portion 24 upon which material is loaded and discharged. A pair of wheels 26a and 26b are rotatably mounted on opposite sides of the rails 15 and the carriage 20 as shown in FIG. 1 and enable moving the hand truck over a supporting surface such as the ground. More specifically, the illustrated wheels 26a and 26b are mounted on an axle 28 proximate the inboard end portion of the carriage near the juncture of the carriage and the rails. These wheels can be 15″ to 20″ in diameter to facilitate moving the hand truck over rough terrain. The axle 28 rotatably receives the wheels at opposite ends thereof. In one embodiment, rather than using an axle that extends across the width of the truck, short sections of axle can be provided for rotatably receiving each of the wheels, respectively. It will be noted that the first section and second section of the frame are positioned approximately 90 degrees with respect to each other. With the wheels rotatably mounted on the first section of the frame above where the carriage is joined thereto, the hand truck can be tilted forward as shown in FIG. 2a for receiving a log or other heavy material to be loaded thereon. Thus the outbound end portion 24 of the carriage can be moved or tilted below the axis 27 upon which the wheels are mounted to facilitate loading a log on the carriage. The log can then be moved onto the outboard end portion of the carriage in the position as shown in FIG. 2a and then the carriage can be tilted upwardly in the direction of the arrow 30 as shown in FIG. 2b such that the carriage can then be pushed over a supporting surface by an operator.

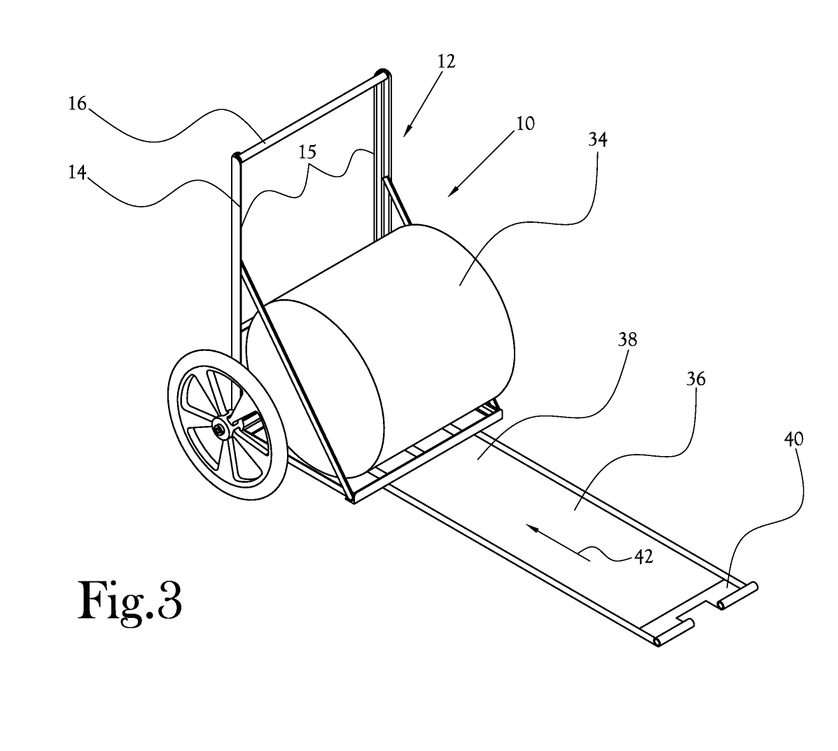

Pursuant to several features of the present general inventive concept, the hand truck 10 may also provide a loading strap. For example, in the embodiment of FIG. 3, to facilitate loading and transporting a load illustrated diagrammatically at 34 by the hand truck 10, a loading strap 36 is provided. This loading strap includes one end portion 38 that is connected to the outboard end portion of the carriage 20. The opposite end portion 40 of the loading strap 36 can be pulled forward in front of the carriage such that the load 34 can be rolled or moved thereon. Then the loading strap 36 can be lifted up towards the handle 16 causing the load to move in a direction of the arrow 42 until it is received as shown in FIG. 3 on the carriage. The outboard end portion 40 of the loading strap can then be gripped by an operator at the strap end is moved proximate the handle 16. Additionally, means such as a hook or other connecter can be provided on the handle to hold the outboard end portion 40 of the load strap 36 during transport of the material 34. Then the loading strap can be lowered to the ground as shown in FIG. 3 for unloading the log or other material 34.

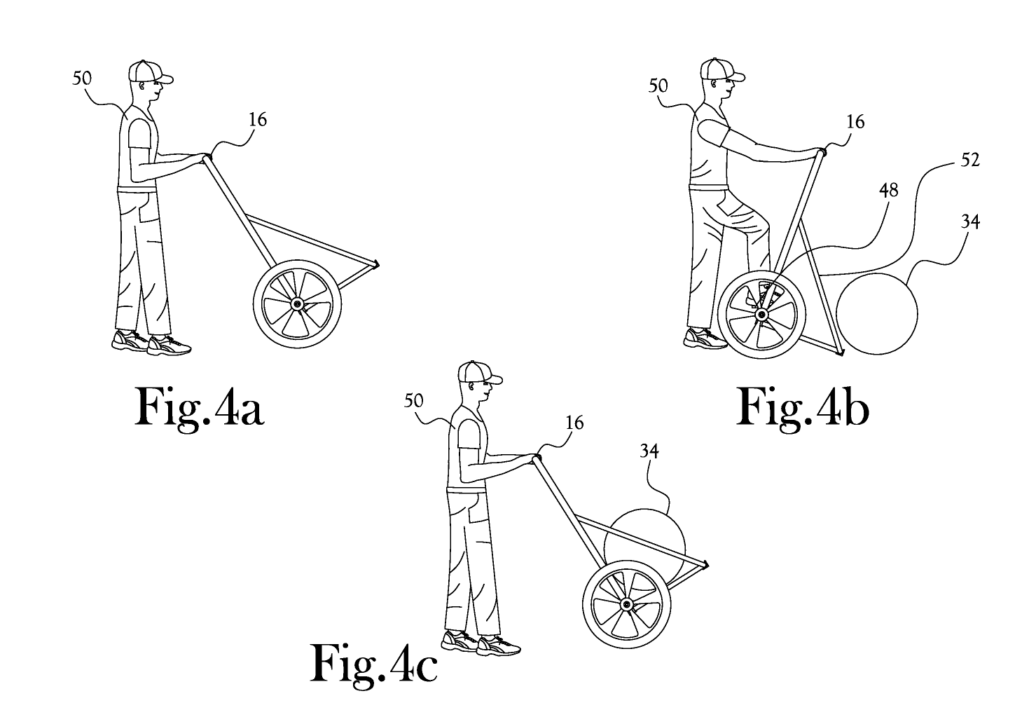

Two methods are typically used in loading a log or other heavy material onto the carriage for transportation. The first method shown in FIGS. 4a-4c is for smaller logs.

Smaller logs can be used without the loading strap. In this connection, the outboard end of the carriage 52 is positioned up against the log 34 on the ground as shown in the first picture in FIG. 4b. From the rear, the operator 50 positions one foot on the cross-beam 48 or rail of the carriage to keep the carriage from moving. As shown in FIG. 4c, the operator 50 can then reach through the opening between the rails in the first section and grab the log and roll it onto the carriage while pulling back on the handle 16. With the log secured on the truck, it can then be moved to a log splitting area or to a truck/trailer.

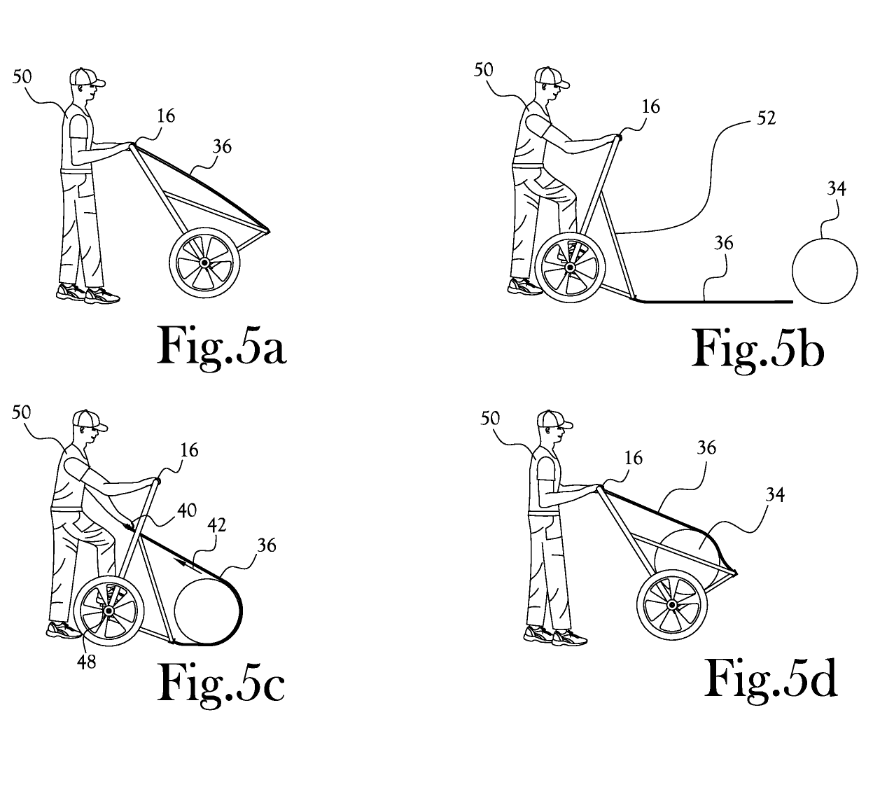

Heavier logs can be loaded onto the truck by using the loading strap. This technique is shown in FIGS. 5a-5d. In this regard, the outboard end portion 52 of the carriage is positioned close to the log on the ground. As shown in FIG. 5b, the load strap 36 is extended to the proximate position of the log 34, and the log 34 is rolled onto the load strap 36 and up against the outboard portion of the carriage. As shown in FIG. 5c, the load strap 36 is then moved over the top of the log 34 with respect to its position on the carriage, and the user will go to the back of the truck, position one foot on the cross beam 48 or cross rail to keep the truck from moving. Then the user 50 can grab the handle 16 with one hand and reach through the opening in the upper section of the frame and grab the outboard end of the loading strap 40 with the other hand. As the user pulls the load strap by pulling back on the handle 16 of the truck, the log will roll towards the rear portion of the carriage such that it can transported to a log splitting area or a truck/trailer as shown in FIG. 5d.

To facilitate stabilizing a log or other heavy material 34 on the carriage 20 during transport, the carriage includes a plurality of rails 44 shown in FIG. 1. These rails may define a substantially triangular outline such that the upper edge portion of the rails slightly embeds into load 34 thereby stabilizing it during transport. Alternatively, the rails may be flat on the top surface, and the rails 44 on upper section of the frame may be triangular and/or flat as desired.

Moreover, a pair of braces 46 can be provided to connect the lower frame section or carriage 20 and the upper frame section 14. These braces 46 provide additional support and stability especially for heavy loads such as logs.

In accordance with one feature of the present invention, the outboard end portion of the carriage laden with a log can be moved in position along the edge of a log splitter and the log rolled from the carriage onto the log splitter as the handle is lifted and tilted away from the user. Cleats can be placed on the underside of the outboard end portion of the carriage which can assist in grabbing the frame of the log splitter during unloading. This feature allows a user to place a log onto a log splitter in a manner that increases the safety of the operator's hands, and prevents re-lifting the log into place on the log splitter.

It will be noted that the hand truck of the present invention provides a means for easily transporting heavy logs to either a truck/trailer or log-splitting area. The ease of lifting is enhanced by the lever action of the frame as it is rotated on the wheels and the rotation of the log provided by the loading strap. Moreover the large diameter, rubber, non-pneumatic, knobby tires allow for easy transport and safe rolling through rough terrain and up ramps to a truck bed or trailer.

While the present invention has been illustrated by description of one embodiment, and while the illustrative embodiment has been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A hand truck for moving logs or other heavy material comprising a frame having a first section for being gripped by a user to manipulate and push the hand truck, and a second section defining a carriage extending outwardly from said first section, said carriage serving as a loading platform for holding and supporting material loaded thereon;
a pair of wheels rotatably mounted on said carriage to enable moving said hand truck over a supporting surface such as the ground; and
a loading strap for facilitating movement of a log or other material to be handled by the hand truck onto said carriage.

2. A hand truck for moving logs or other heavy material comprising a frame having a parallel pair of upright rails having upper and lower end portions;
a handle connecting the upper end portions of said rails and suitable for being gripped by a user for manipulating and pushing the hand truck;
a carriage extending outward from the lower end portions of said rails opposite the end portions upon which the handle is mounted, said carriage serving as a loading platform for holding and transporting material loaded thereon and including an inboard end portion and an outboard end portion upon which material is loaded and discharged;
a pair of wheels rotatably mounted on opposite sides of said carriage to enable moving said hand truck over a supporting surface such as the ground; and
a loading strap for facilitating movement of a log or other material to be handled by the hand truck onto said carriage, said load strap having one end secured to the outboard end portion of said carriage and an opposite end which can be held by an operator pushing the hand truck while gripping the handle thereof.

3. The hand truck of claim 2 wherein said wheels include a diameter of more than 15 inches; and an axle mounted proximate the inboard end portion of said carriage for rotatably receiving said wheels at the opposite ends thereof.

4. The hand truck of claim 2 wherein a pair of said rails define an opening through which the user can reach.

5. The hand truck of claim 2 wherein said carriage extends outwardly from said upright rails at an angle of approximately 90°.

7. The hand truck of claim 2 wherein said pair of wheels are mounted on an axle proximate said inboard end portion of said carriage near a juncture of said carriage and said rails.

9. The hand truck of claim 2, wherein said wheels are rotatably mounted on the first section of said frame above where said carriage is joined thereto, thereby allowing said hand truck to be tilted forward receiving a log or other heavy material to be loaded thereon.

10. The hand truck of claim 2, wherein said outboard end portion of said carriage can be moved or tilted below the axis upon which said wheels are mounted to facilitate loading a log or other heavy material on said carriage.

11. The hand truck of claim 2, wherein one or more braces are provided to connect said lower frame section of said carriage and said upper section of said frame.

12. The hand truck of claim 2, wherein one or more cleats are placed on an underside of said outboard end portion of said carriage.

13. A method of loading and transporting a load using a hand truck, comprising the steps of
a. positioning an outboard end of a carriage of the hand truck against the load on a supporting surface such as the ground;
b. positioning one foot on a rail of the carriage from the rear of the hand truck to keep the carriage from moving; and
c. moving the load onto the outboard end portion of the carriage and tilting the hand truck in an upward direction to allow the load to move towards an inboard portion of the carriage until the load is received on the carriage for storage and transportation.

14. The method of claim 13, further comprising the steps of
a. securing one end of a loading strap to an outboard end portion of said carriage and extending an opposite outboard end of the loading strap to a proximate position of the load;
b. rolling or moving the load onto the loading strap and up against the outboard portion of the carriage; and
c. lifting the opposite outboard end of the loading strap towards a member of the hand truck such as the handle and enabling the load to move along the loading strap from the outboard portion of the carriage to the inboard portion of the carriage until the load is received on the carriage for storage and transportation.
